(19) United States
(12) Patent Application Publication
(10) Pub. No.: US 2014/0263641 A1
(43) Pub. Date: Sep. 18, 2014

(54) METHOD AND INFORMATION CARRIER FOR DISTRIBUTING AND/OR TRANSMITTING INFORMATION

(71) Applicant: Wolfgang Hammer, Wiesloch (DE)

(72) Inventors: Wolfgang Hammer, Wiesloch (DE); Matthias Niederhausen, Oftersheim (DE)

(21) Appl. No.: 14/352,936

(22) PCT Filed: Oct. 1, 2012
(86) PCT No.: PCT/DE2012/200065

§ 371 Date: Apr. 18, 2014

(30) Foreign Application Priority Data
Oct. 20, 2011 (DE) 10 2011 084 892.4

(51) Int. Cl. G06Q 30/06; G06K 19/06; G06K 7/14

(52) U.S. Cl. CPC G06Q 30/0623; G06K 7/1404; G06K 19/06009; G06K 19/06037
USPC 235/435; 235/494

(57) ABSTRACT

The invention relates to a method for distributing and/or transmitting information. An information carrier comprises a code, said code being read and processed by an addressable reading device. The reading device carries out a location determination which is triggered by the code, and an operation which is defined by the code is triggered on the reading device, said operation causing a response which is addressed to the reading device. The invention is characterized in that the location is displayed on the reading device. The invention further relates to a corresponding information carrier.

### CROSS REFERENCE TO RELATED APPLICATIONS

This application is a national stage application, filed under 35 U.S.C. §371, of International Application No. PCT/DE2012/200065, filed Oct. 1, 2012, which claims priority to German Application No. 10 2011 084 892.4, filed Oct. 20, 2011, all of which are hereby incorporated by reference in their entirety.

### BACKGROUND

1. Technical Field

The invention relates to a method for distributing and/or transmitting information. The invention further relates to an information carrier for distributing and/or transmitting information.

2. Description of Related Art

Basically, this concerns the transmission or disclosure of information with respect to a specific product, which information should be conveyed to a potential consumer of the product. As an example, the specific product can be a certain type of merchandise or a service.

Methods and information carriers of the type discussed have been known from experience for years. Accordingly, information about a specific product can be communicated to potential consumers via placards, flyers, print media, video advertisements, etc. Often, de facto opportunities are offered to potential consumers, in order that they may obtain further, more detailed information about the specific product. This includes, for example, information about where or how a potential consumer can purchase the product in which the consumer is interested. Thus, for example, a website can be specified on a placard, by means of which the consumer can obtain the desired information. This is, however, problematic, as the consumer, insofar as he/she is interested in the specific product, must note the website address in order to be able to enter it at a later time into an internet-capable device. In any case, the potential consumer must make a few inconvenient steps in order to be able to acquire the desired product. This is costly and inconvenient for the interested consumer.

Therefore, the object of the present invention is a method and an information carrier for distributing and/or transmitting information such that an effective dissemination of the information and a convenient added value for the consumer can be achieved using simple design means.

### BRIEF SUMMARY

According to the invention, the preceding problem is solved by the features of claim 17. Accordingly, a method for distributing and/or transmitting information is claimed, wherein an information carrier comprises a code, wherein the code is read and processed via an addressable reader, wherein the reader carries out a location determination triggered by the code, and wherein an operation defined by the code is triggered on the reader, said operation causing a response addressed to the reader. The method is characterized in that the location is displayed on the reader.

With respect to the information carrier according to the invention, the preceding problem is solved by the features of claim 36. Accordingly, an information carrier for distributing and/or transmitting information is disclosed having an applied code, in particular a QR code, wherein the code is read and processed by an addressable reader, in particular a mobile radio device, smartphone, PDA, portable media player or similar, wherein the reader carries out a location determination triggered by the code, and wherein an operation defined by the code is triggered on the reader, said operation causing a response addressed to the reader.

It is initially recognized as significantly advantageous according to the invention if an information carrier with a code is used to distribute information. A QR code (Quick Response Code) or similar two-dimensional code lends itself ideally to this purpose. Specifically, the burdensome notation of information on the part of the consumer can be thereby avoided, as the code is read and processed via a reader. Any mobile devices having a camera are considered as readers, for example current conventional mobile radio devices, smartphones, PDA's (Personal Digital Assistants), portable media players, or similar. It is further recognized according to the invention that the steps previously required on the part of the consumer for purchasing the product can be substantially simplified if the current position of the consumer is included in the supply of information. For this purpose, the reader carries out a location determination triggered by the code after the reader has processed or decoded the code. Further, an operation and/or action defined by the code is triggered on the reader, said operation causing a response which is addressed to the reader. The operation can thereby be a process that comprises a plurality of operation steps. Thus, in a surprisingly simple way, the current position of the consumer can thereby be used to supply the consumer with information about the specific product, which information is tailored to the current location of the consumer. Ideally, a software application for the reader is provided for processing the code, for location determination, and for triggering the operation/action.

As a result, the method according to the invention and the information carrier according to the invention achieve an effective distribution of the information and a convenient added value for the consumer using simple design means.

In a particularly advantageous way, a sales receipt, packaging preferably for food or drink, packaging for a medication, a coupon, an advertising placard, a flyer, a stamp, an entrance ticket, etc. can be used as the information carrier. The packaging serves for recording and/or displaying the code. It should be noted that the terms food and/or drink are to be understood in the broadest sense, namely to the effect that semi luxury foods like tobacco and miscellaneous alcohols are also included. The reference to food and drink thus does not effect a limitation in the sense of the claimed teaching.

In an additional advantageous way, a television image can be used as an information carrier, wherein the code is integrated in a preferably audiovisual broadcast. By using and integrating the code, for example, in the image of a television broadcast displayed on a television device and/or monitor, the interest of the consumer can be awakened in a simple way. Thus, the code can be inserted during a broadcast and without interrupting the broadcast in order to arouse curiosity on the part of the consumer.

In an advantageous embodiment, the operation can comprise establishing an internet connection via a wireless interface, preferably by means of WLAN (Wireless Local Area Network), UMTS (Universal Mobile Telecommunications System), EDGE (Enhanced Data Rates for GSM Evolution), HSDPA (High Speed Downlink Packet Access), GPRS (General Packet Radio Service), LTE (3GPP Long Term Evolution), etc.

In an advantageous embodiment, the reader can correspond via the internet with a server, for example a database server or web server, wherein the code comprises an identification address for addressing the server. In this case, a Uniform Resource Identifier (URI) is conceivable as an identification address, which URI represents an identifier and consists of a character string which serves to identify an abstract or physical resource. By this means, resources like, for example, websites, miscellaneous files, and/or internet web services can be addressed.

With regard to a specific embodiment, a program for the reader can be loaded within the scope of the operation via the internet as a result of the processed code and installed on the reader. Specifically, this program can be a program with a direct relationship to a specific product or a specific service. It is thus conceivable, for example, that the products and/or offers from a fitness studio can be supported to the effect that a training application for the fitness studio visit is provided with the program.

In an especially advantageous way, a program can be preferably automatically called on the reader via the code, wherein the location determination of the reader is carried out by the program. I.e., calling the program for location determination can be initiated by reading the code using the reader.

With respect to the most accurate positioning possible, the location determination of the reader can be executed using a satellite navigation system, in particular GPS (Global Positioning System), and/or Galileo.

In an advantageous embodiment, the current location of the reader can be displayed on the reader using a corresponding program. Thus, the consumer and/or the user of the reader can receive his/her current position displayed e.g. on a topographic and/or street map.

In a particularly advantageous way, the information can comprise information in regards to a specific product, for example a certain type of merchandise or a specific service.

With respect to an added value for the consumer, the reader can, within the scope of the operation, determine and display destination locations within a prespecified area, wherein the destination locations offer the specific product and/or the specific service. It is thereby conceivable, that all points of sales, restaurants, bars, or events in the vicinity are displayed as destination locations where the specific product and/or the specific service can be obtained.

For example, if a medication is the specific product, linked destination locations like hospitals, doctors' offices, and/or apothecaries in the vicinity can form a specific added value for the consumer. While the consumer scans the code with his/her reader, said code being applied to the packaging of the medication or to the associated sales receipt, the reader can display the most important destination locations in the vicinity of the consumer in case of emergency.

Furthermore, destination locations such as roadside assistance and/or repair shops are advantageous destination locations that can be linked using a code that is printed on a sales receipt from a filling station.

In an especially advantageous embodiment, the reader can provide the consumer with directions to the destination location.

In a further preferred embodiment, a specific product and/or a specific service can be reserved within the scope of the operation. Conceivable items are, for example, hotel reservations, events, janitorial services, taxi service, etc.

Furthermore, a ticket for short-distance or long-distance public transportation can be reserved within the scope of the operation, in particular from the current location of the reader to a destination location.

In an advantageous way, specific product and/or service information, especially with respect to price, availability, origin, storage, use, warranty, etc., can be displayed on the reader within the scope of the operation.

In a specific embodiment, a profile of a social network of a user of the reader can be used within the scope of the operation in such a way that information triggered by the code in relation to the specific product and/or the specific service can be incorporated into the profile of the user in the social network. Profiles on social networks such as Facebook, MSN, Twitter, etc., are thereby conceivable.

### BRIEF DESCRIPTION OF THE FIGURE

At this point, there are various options for equipping and implementing the teaching of the present invention in an advantageous manner. Reference is therefore made on the one hand to the dependent claims, and on the other hand to the subsequent explanation of an exemplary embodiment of the invention by means of the drawing. Generally exemplary embodiments and developments of the teaching are also explained in connection with the explanation of the exemplary embodiment by means of the drawing. As seen, the single

FIGURE shows a schematic view of an embodiment of the method according to the invention and the information carrier according to the invention.

### DETAILED DESCRIPTION OF VARIOUS EMBODIMENTS

The single FIGURE shows in a schematic representation the basic function of the method according to the invention, according to which an information carrier 1 is imprinted with a code 2 in the form of a QR code. The information carrier surrounds a drink (not shown in the single FIGURE) as packaging. The code 2 on the information carrier 1 is read and processed by the consumer K using the reader 3.

By means of the code 2, the reader is commanded to carry out a location determination by means of GPS. After decoding the code 2, the reader 3 further obtains a web address of a website 6 encoded in the code 2 and performs the operation defined by the code 2.

The reader 3 can provide the consumer K, via a message, with the option of approving or declining the execution of the operation.

If the consumer K approves of the execution of the operation, then the reader 3 automatically establishes a link, by means the decoded web address encoded in the code 2, via the internet 4 to a server 5 in the form of a web server. The server 5 subsequently transmits the requested data, for example a website 6, to the reader 3 via the internet 4. The website 6 can be viewed by the consumer K using a display or a display device of the reader 3. On the website, the location of the consumer is visualized in a map view as well as the destination locations. The destination locations are places where a specific product can be obtained.

It is initially recognized as significantly advantageous according to the invention if an information carrier with a code is used to distribute information. A QR code (Quick Response Code) or similar two-dimensional code lends itself ideally to this purpose. Specifically, the burdensome notation of information on the part of the consumer can be thereby avoided, as the code is read and processed via a reader. Any mobile devices having a camera are considered as readers, for example current conventional mobile radio devices, smartphones, PDA's (Personal Digital Assistants), portable media players, or similar. It is further recognized according to the invention that the steps previously required on the part of the consumer for purchasing the product can be substantially simplified if the current position of the consumer is included in the supply of information. For this purpose, the reader carries out a location determination triggered by the code after the reader has processed or decoded the code. Further, an operation and/or action defined by the code is triggered on the reader, said operation causing a response which is addressed to the reader. The operation can thereby be a process that comprises a plurality of operation steps. Thus, in a surprisingly simple way, the current position of the consumer can thereby be used to supply the consumer with information about the specific product, which information is tailored to the current location of the consumer. Ideally, a software application for the reader is provided for processing the code, for location determination, and for triggering the operation/action.

As a result, the method according to the invention and the information carrier according to the invention achieve an effective distribution of the information and a convenient added value for the consumer using simple design means.

In a particularly advantageous way, a sales receipt, packaging preferably for food or drink, packaging for a medication, a coupon, an advertising placard, a flyer, a stamp, an entrance ticket, etc. can be used as the information carrier. The packaging serves for recording and/or displaying the code. It should be noted that the terms food and/or drink are to be understood in the broadest sense, namely to the effect that semi luxury foods like tobacco and miscellaneous alcohols are also included. The reference to food and drink thus does not effect a limitation in the sense of the claimed teaching.

In an additional advantageous way, a television image can be used as an information carrier, wherein the code is integrated in a preferably audiovisual broadcast. By using and integrating the code, for example, in the image of a television broadcast displayed on a television device and/or monitor, the interest of the consumer can be awakened in a simple way. Thus, the code can be inserted during a broadcast and without interrupting the broadcast in order to arouse curiosity on the part of the consumer.

In an advantageous embodiment, the operation can comprise establishing an internet connection via a wireless interface, preferably by means of WLAN (Wireless Local Area Network), UMTS (Universal Mobile Telecommunications System), EDGE (Enhanced Data Rates for GSM Evolution), HSDPA (High Speed Downlink Packet Access), GPRS (General Packet Radio Service), LTE (3GPP Long Term Evolution), etc.

In an advantageous embodiment, the reader can correspond via the internet with a server, for example a database server or web server, wherein the code comprises an identification address for addressing the server. In this case, a Uniform Resource Identifier (URI) is conceivable as an identification address, which URI represents an identifier and consists of a character string which serves to identify an abstract or physical resource. By this means, resources like, for example, websites, miscellaneous files, and/or internet web services can be addressed.

With regard to a specific embodiment, a program for the reader can be loaded within the scope of the operation via the internet as a result of the processed code and installed on the reader. Specifically, this program can be a program with a direct relationship to a specific product or a specific service. It is thus conceivable, for example, that the products and/or offers from a fitness studio can be supported to the effect that a training application for the fitness studio visit is provided with the program.

In an especially advantageous way, a program can be preferably automatically called on the reader via the code, wherein the location determination of the reader is carried out by the program. I.e., calling the program for location determination can be initiated by reading the code using the reader.

With respect to the most accurate positioning possible, the location determination of the reader can be executed using a satellite navigation system, in particular GPS (Global Positioning System), and/or Galileo.

In an advantageous embodiment, the current location of the reader can be displayed on the reader using a corresponding program. Thus, the consumer and/or the user of the reader can receive his/her current position displayed e.g. on a topographic and/or street map.

In a particularly advantageous way, the information can comprise information in regards to a specific product, for example a certain type of merchandise or a specific service.

With respect to an added value for the consumer, the reader can, within the scope of the operation, determine and display destination locations within a prespecified area, wherein the destination locations offer the specific product and/or the specific service. It is thereby conceivable, that all points of sales, restaurants, bars, or events in the vicinity are displayed as destination locations where the specific product and/or the specific service can be obtained.

For example, if a medication is the specific product, linked destination locations like hospitals, doctors' offices, and/or apothecaries in the vicinity can form a specific added value for the consumer. While the consumer scans the code with his/her reader, said code being applied to the packaging of the medication or to the associated sales receipt, the reader can display the most important destination locations in the vicinity of the consumer in case of emergency.

Furthermore, destination locations such as roadside assistance and/or repair shops are advantageous destination locations that can be linked using a code that is printed on a sales receipt from a filling station.

In an especially advantageous embodiment, the reader can provide the consumer with directions to the destination location.

In a further preferred embodiment, a specific product and/or a specific service can be reserved within the scope of the operation. Conceivable items are, for example, hotel reservations, events, janitorial services, taxi service, etc.

Furthermore, a ticket for short-distance or long-distance public transportation can be reserved within the scope of the operation, in particular from the current location of the reader to a destination location.

In an advantageous way, specific product and/or service information, especially with respect to price, availability, origin, storage, use, warranty, etc., can be displayed on the reader within the scope of the operation.

In a specific embodiment, a profile of a social network of a user of the reader can be used within the scope of the operation in such a way that information triggered by the code in relation to the specific product and/or the specific service can be incorporated into the profile of the user in the social network. Profiles on social networks such as Facebook, MSN, Twitter, etc., are thereby conceivable.

Finally, reference is explicitly made to the fact that the previously described embodiment of the method according to the invention and the information carrier according to the invention serve merely as an explanation of the claimed teaching; however they are not limited to the embodiment.

### Reference List

1 Information carrier
2 Code
3 Reader
4 Internet
5 Server
6 Website
K Consumer

1-16. (canceled)

17. Method for distributing and/or transmitting information, wherein an information carrier (1) comprises a code (2), the method comprising the steps of:
reading and processing the code (2) via an addressable reader (3);
determining a location of the reader (3) via the addressable reader (3), the determination being triggered by the code (2); and
triggering via the addressable reader (3) an operation defined by the code (2),
wherein:
said operation causes a response addressed to the reader (3); and
the location is displayed on the reader (3).

18. Method according to claim 17, wherein at least one of a sales receipt, packaging from food and/or drink, packaging for a medication, a coupon, an advertising placard, a flyer, a stamp, or an entrance ticket is used as the information carrier (1).

19. Method according to claim 17, wherein:
a television image is used as the information carrier (1); and
the code (2) is integrated in an audiovisual broadcast.

20. Method according to claim 17, wherein the operation comprises the establishment of an internet connection via a wireless interface.

21. Method according to claim 20, wherein the wireless interface comprises at least one of a WLAN, a UMTS, an EDGE, a HSDPA, a GPRS, or a LTE.

22. Method according to claim 17, wherein:
the reader (3) is configured to communicate via the internet (4) with a server (5); and
the code (2) comprises an identification address for addressing the server (5).

23. Method according to claim 22, wherein the server (5) comprises at least one of a database server or a web server.

24. Method according to claim 17, further comprising the steps of loading a program via the internet (4) and installing the loaded program on the reader (3).

25. Method according to claim 17, wherein:
a program is automatically called on the reader (3) via the code (2); and
the step of determining the location of the reader (3) is executed by the program.

26. Method according to claim 17, wherein the step of determining the location is executed using a satellite navigation system.

27. Method according to claim 26, wherein the satellite navigation system comprises at least one of GPS (Global Positioning System) or Galileo.

28. Method according to claim 17, wherein the information comprises information in regards to at least one of a specific product or a specific service.

29. Method according to claim 28, wherein:
the reader (3) within the scope of the operation is configured to determine and display at least one destination location in a pre-specified area; and
the destination location offers at least one of the specific product or the specific service.

30. Method according to claim 28, wherein the reader (3) provides directions to the destination locations.

31. Method according to claim 17, wherein at least one of a specific product or a specific service is reserved within the scope of the operation.

32. Method according to claim 17, wherein a ticket for at least one of short-distance or long-distance public transportation can be reserved within the scope of the operation, in particular from the current location of the reader (3) to a destination location.

33. Method according to claim 17, wherein at least one of specific product or service information is displayed on the reader (3) within the scope of the operation.

34. Method according to claim 33, wherein the specific product or service information comprises at least one of price, availability, origin, storage, use, or warranty.

35. Method according to claim 17, wherein a profile of a social network of a user of the reader (3) is used within the scope of the operation in such a way that information triggered by the code (2) in relation to the specific product or the specific service can be incorporated into the profile of the user in the social network.

36. Information carrier (1) for distributing and/or transmitting information, in particular for executing a method according to claim 17, having an applied code (2), wherein the code (2) can be read and processed by an addressable reader (3), wherein the reader (3) executes a location determination triggered by the code (2), and wherein an operation defined by the code (2) is triggered on the reader (3), said operation causing a response addressed to the reader (3).

37. Information carrier (1) according to claim 36, wherein the applied code (2) comprises a QR code.

38. Information carrier (1) according to claim 36, wherein the addressable reader (3) comprises at least one of a mobile radio device, a smartphone, a PDA, or a portable media player.
